(19) United States
(12) Patent Application Publication
(10) Pub. No.: US 2004/0203376 A1
(43) Pub. Date: Oct. 14, 2004

(54) Method for establising a connection in a wireless communication system

(76) Inventor: John Quentin Phillipps, London (GB)

Correspondence Address: Frank Chau, F Chau & Associates, 1900 Hempstead Turnpike, Suite 501, East Meadow, NY, 11554, US

(21) Appl. No.: 10/312,018

(22) PCT Filed: May 1, 2001
(86) PCT No.: PCT/GB01/01916

(30) Foreign Application Priority Data
Jul. 3, 2000 (GB) 0016364.2

(51) Int. Cl. H04B 5/00

(52) U.S. Cl. 455/41.2; 455/517

(57) ABSTRACT

Communication between two devices, e.g. a PDA (10) and a mobile phone (12), is initially established using a point-to-point channel, such as by infrared signalling, before switching to a broadcast rf channel for the transfer of data. Consequently, devices can be added to a wireless network easily in an environment containing many devices which are available to join a wireless network.

### FIELD OF THE INVENTION

The present invention relates to wireless communication.

### BACKGROUND TO THE INVENTION

Devices implementing the Bluetooth standard have recently begun to appear. Bluetooth provides a common standard by which devices, such as PDAs (Personal Digital Assistants), mobile phones, printers, etc., can communicate with each other wirelessly. Bluetooth uses radio signals in the 2.4 GHz Industrial-Scientific-Medical band.

Bluetooth has a weakness in that problems arise in discovering an intended recipient for a communication in a crowded environment, such as a conference where many people are exchanging electronic business cards or on a commuter train where many people have Bluetooth connections between mobile phone or music playing devices and ear phones. A Bluetooth device must perform a time-consuming discovery operation which will actually locate every Bluetooth device in the local environment.

### SUMMARY OF THE INVENTION

According to the present invention, there is provided a method of establishing a wireless connection between two devices, the method comprising:

sending a first signal from a first device to a second device by means of a point-to-point channel using other than radio frequency waves; and

sending a second signal from the first device to the second device,

characterised in that the first signal communicates set up information for a broadcast wireless rf channel to the second device and said broadcast channel is used for said second signal.

In the present document, the term “broadcast” is used to distinguish substantially non-directional transmission from directional, point-to-point transmission rather than to refer to signals intended to be received by more than one station concurrently. The term “set up information” means information for use by the second device for setting up its broadcast channel transmissions, not merely an alert signal. The use of a simple infrared alert signal, which does not convey set up information, in a system also employing rf wireless communication is disclosed in JP-A-08-204791.

The first signal need not be followed immediately by the second signal. For example, a degree of mutual identification and negotiation may be effected using the point-to-point channel before the second signal is sent.

The point-to-point channel may use a cable as a medium or induction communication. However, it preferably uses an optical carrier. An optical fibre may be used for the point-to-point channel but this is not preferred.

The set up information preferably comprises data defining a channel, more preferably including a frequency hopping scheme.

The first signal may include an encryption key to provide security for subsequent communication using the broadcast channel. The private nature of the point-to-point channel means that codes other than public key codes, including PGP, can be used. As an alternative to encryption as such, the rf communication may be effected using a spread spectrum technique in which the carrier is phase-shift modulated with a pseudorandom sequence at a rate greater than the data rate.

According to the present invention, there is provided a method of establishing a wireless network connection between two devices, the method comprising:

sending a network admission request signal from the second device to the first device;

determining whether the second device should be admitted to a network including the first device; and

if it is determined that the second device should be admitted to the network, performing a method of establishing a wireless connection between two devices according to the present invention,

wherein the network admission request signal is sent in said point-to-point channel.

The first device may invite the second device to send the network admission request signal by sending a suitable signal to the second device using the point-to-point channel.

According to the present invention, there is provided a device having a communications facility, the device including rf transceiver means, a non-radio point-to-point transceiver means and control means for controlling the rf and point-to-point transceiver means, processing data for transmission thereby and processing data received thereby, wherein the control means is programmed such that the device is configured to serve as the first device or the second device in a method according to the present invention.

Preferably, the point-to-point transceiver means is an optical transceiver means.

A device according to the present invention may be embodied inter alia in a computer, a mobile phone or a printer.

### BRIEF DESCRIPTION OF THE DRAWINGS

FIG. 1 shows a device according to the present invention;

FIG. 2 illustrates the frequency hopping employed by the device of FIG. 1;

FIG. 3 shows a wireless network formed according to the present invention;

FIG. 4 shows two devices establishing a wireless network;

FIG. 5 shows a first signalling scheme for setting up a wireless channel between two devices;

FIG. 6 shows a further device being added to the wireless network; and

FIG. 7 shows a second signalling scheme for setting up a wireless channel between devices.

### DETAILED DESCRIPTION OF PREFERRED EMBODIMENT

An embodiment of the present invention will now be described, by way of example, with reference to the accompanying drawings.

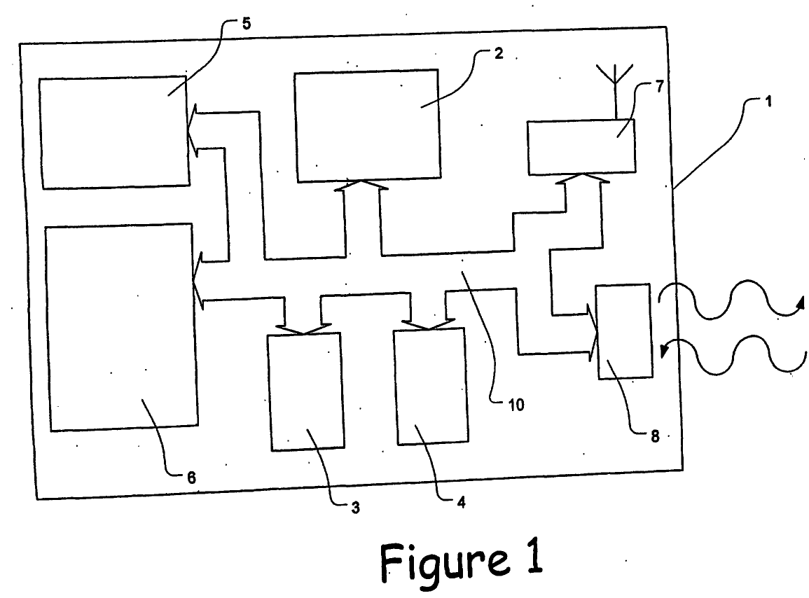

Referring to FIG. 1, a device 1 according to the present invention, which may be a PDA, a mobile phone, a printer or other device, comprises a processor 2, RAM 3, ROM 4, display circuitry 5, user input circuitry 6, an rf subsystem 7 and an ir subsystem 8 interconnected by a bus 10. The device 1 may have additional circuits and mechanical elements (not shown) which are required for its particular function, e.g. signal processing in the case of a mobile phone and a printing engine in the case of a printer.

The ROM 4 contains routines for controlling communication using the rf and ir subsystems 7, 8 which are accessible to programs being run by the processor 2 via an API.

The rf subsystem 7 comprises transceiver circuitry, including a local oscillator, and a controller for controlling the transceiver circuitry in response to commands from the processor 2. The transceiver is adapted for frequency hopping transmission and reception.

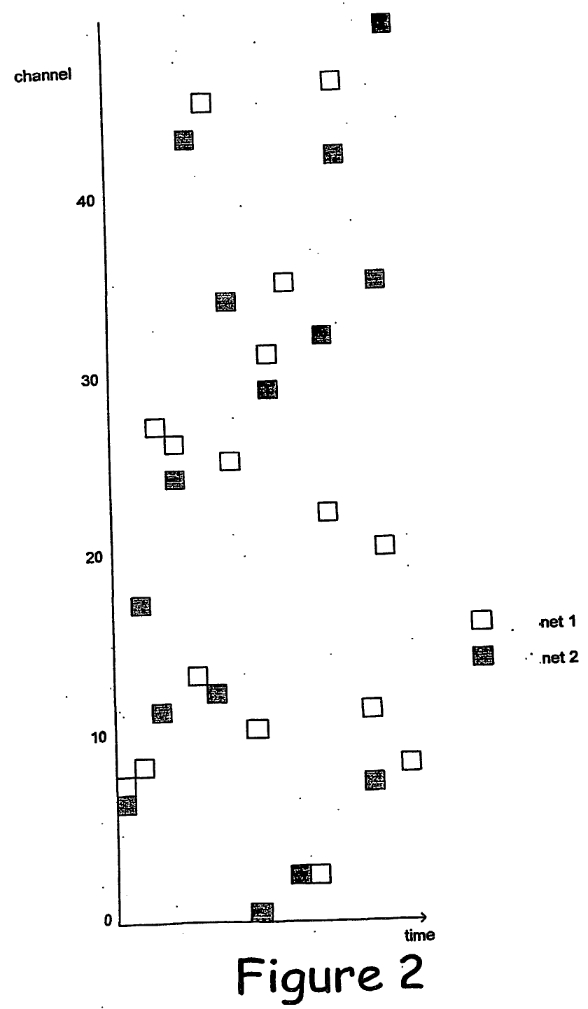

Referring to FIG. 2, which shows the frequency hopping patterns of two wireless networks which may operate in overlapping areas, a 50 MHz wide portion of the spectrum in the 2.4 GHz ISM band is divided into 50 channels with carriers spaced by 1 MHz. The device 1 transmits data in packets in respective 2 ms time slots, changing frequency between time slots. One packet may be transmitted using a plurality of successive time slots and a plurality of packets may be transmitted in one time slot. The frequency hopping is pseudorandom and the channel to be used for any given packet can be determined using a “seed” value for the controlling pseudorandom sequence and the number of time slots since the pseudorandom sequence was last at its start. The right of a device to transmit is independent of the frequency hopping scheme, devices in a wireless network transmitting on the frequency determined by the pseudorandom sequence for the wireless network that they are in.

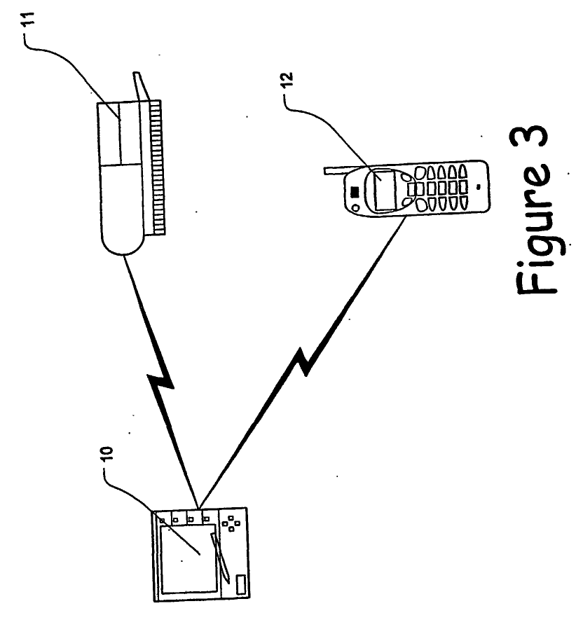

Referring to FIG. 3, a exemplary wireless network comprises a PDA 10, a mobile phone 11 and a printer 12 all of which have the elements shown in the device of FIG. 1. The PDA 10 is the master and can communicate directly with both the mobile phone 11 and the printer 12. However, the mobile phone 11 and the printer 12 are slaves and can only communicate with each other via the PDA 10. The same pseudorandom sequence, and hence the same frequency hopping scheme, is used for all communications between the PDA 10, the mobile phone 11 and the printer 12.

The establishment of a wireless link between the PDA 10 and the mobile phone 11 will now be described.

When available for communication, all devices according to the present invention monitor their environment for ir signals. A user may disable the ir subsystem 8 to conserve battery power when the user does not wish the device to be available for communication. The ir subsystem 8 could also be disabled by a timer, if it is not used for some period.

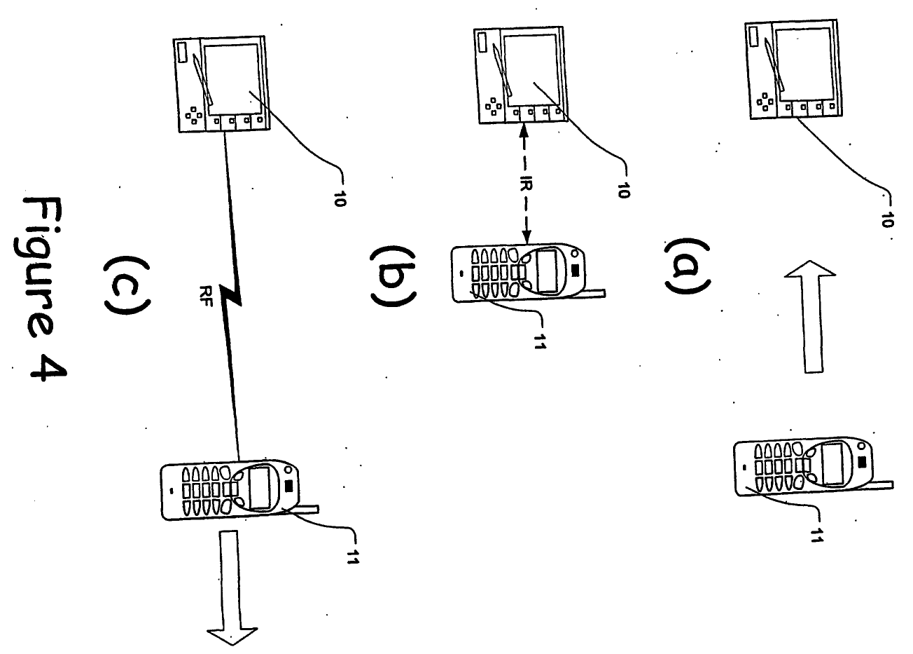

In order to connect the mobile phone 11 to the PDA 10, the mobile phone 11 is brought towards the PDA 10 (FIG. 4(a)) so that their ir ports are aligned (FIG. 4(b)).

At this point, neither the PDA 10 nor the mobile phone 11 has been designated master. Whilst this could be left to the PDA 10 and the mobile phone 11 to sort out amongst themselves, in the present embodiment the user or users of the devices can allocate the role to the devices 10, 11. It will be assumed that the PDA 10 is to be the master.

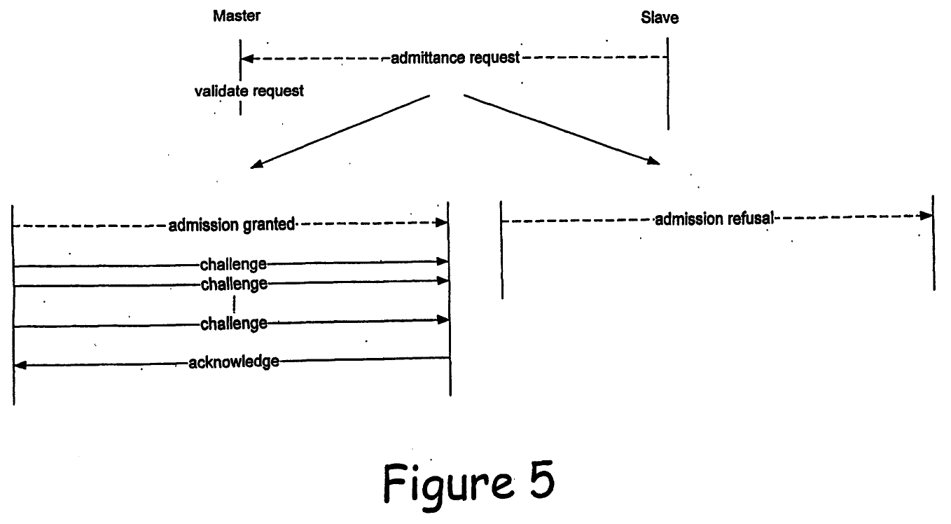

When the ir ports of the PDA 10 and the mobile phone 11 are aligned, the user of the mobile phone 11 inputs a “connect” command. Referring to FIG. 5, the mobile phone 11 responds by sending an “admittance request” signal to the PDA 10 requesting admittance to its wireless network. At this point, the wireless network is purely notional as the PDA 10 has not yet established communication with any other devices. The “admittance request” signal includes a user-defined or preset “name” given to the mobile phone 11 and a device type code. The PDA 10 determines whether the mobile phone 11I is known to it and should be granted admittance automatically using the name and device type code. To do this, the PDA 10 looks up the mobile phone 11 in a list of “friends” which is controlled by the user. If the mobile phone 11 is not recognised by the PDA 10 as a “friend”, the PDA 10 displays a message for its user, asking whether the mobile phone 11 should be admitted. If the user responds by inputting “no”, the PDA 10 sends a “admittance denied” message to the mobile phone 11. However, if the mobile phone 111 is to be admitted, the PDA 10 selects a pseudorandom number seed, e.g. using an algorithm taking the names of the PDA 10 and the mobile phone 11 as inputs, and listens for 50 ms (i.e. 25 time slots) on the channels specified by the pseudorandom number. If the PDA 10 detects more than 2 bursts having a signal strength above threshold value, it selects another pseudorandom number seed and listens for a further 25 time slots.

If the PDA 10 does not detect more than two bursts over the threshold, it sends an “admission granted” signal to the mobile phone 11 using its ir subsystem 7. The “admission granted” signal comprises the name and device type of the PDA 10, its own wireless network address, a wireless network address to be used by the mobile phone, the pseudorandom number seed, a time slot number and a clock signal synchronised with the frequency hopping scheme established by the PDA 10. The clock signal terminates at the time slot identified in the “admission granted signal”. The “admission granted” signal may optionally carry an encryption key to be used by the slave device, in this case the mobile phone 11, for subsequent rf communication.

When the mobile phone 11 receives the “admission granted” signal, it synchronises the transceiver of its rf subsystem 7 with that of the PDA 10 using the clock signal and slot number in the “admission granted” signal and determines whether it recognises the PDA 10 as a “friend” with whom it may communicate using the PDA's name and device type. If the PDA 10 is not recognised as a “friend”, the mobile phone 11 queries its user, in case the user was mistaken in starting the connection process with the PDA 10. If the user does not authorise the connection in response to the query, the mobile phone 11 puts its rf subsystem 7 back into standby mode. However, if the connection is allowed, the mobile phone 11 starts to listen in the frequency hopping channel determined by the pseudorandom number seed.

During this time, the PDA 10 begins to transmits a number of “challenge” signal packets addressed to the mobile phone 11 using its rf subsystem. When the mobile phone 11 receives one of the “challenge” signal packets it responds with an “acknowledge” signal. If there is no response to the challenge signals, within a certain time or number of packets, the PDA 10 assumes that it has been rejected as a master and stops signalling the mobile phone 11.

For subsequent rf communication, the devices 10, 11 use a modified form of slotted ALOHA in which a percentage of slots are reserved for use by a particular device. For instance, in a 100 time slot frame, one device may have reserved for it, the 20^{th}, 40^{th}, 60^{th}, 80^{th} and 100^{th} times slots in each frame whereas another device which is less likely to need to transmit large amounts of data, e.g. a printer, would have only the 50^{th} time slot reserved. The reserved time slots are determined by the master device in dependence on the device type codes of the devices in its wireless network. Conveniently, the slots that a particular device may not use are initially communicated in the “challenge” packets addressed to it together with the network addresses, names and device types of any additional existing wireless network members.

Once the rf link has been established, the devices 10, 11 can be separated and “hidden” from each other, e.g. the user may place the mobile phone 11 in one pocket and the PDA 10 in another pocket (FIG. 4(c)). The rf link provides a substratum over which a higher level protocol such as TCP/IP can be used.

At this point the PDA's wireless network contains the PDA 10 and the mobile phone 11. It will be assumed that the user now wishes to add the printer 12 to its wireless network. It is not necessarily convenient for the user to move to the printer 12 and operate controls thereon to add it to the wireless network. To solve this problem, a master device, in this case the PDA 10, can invite another device to request admission.

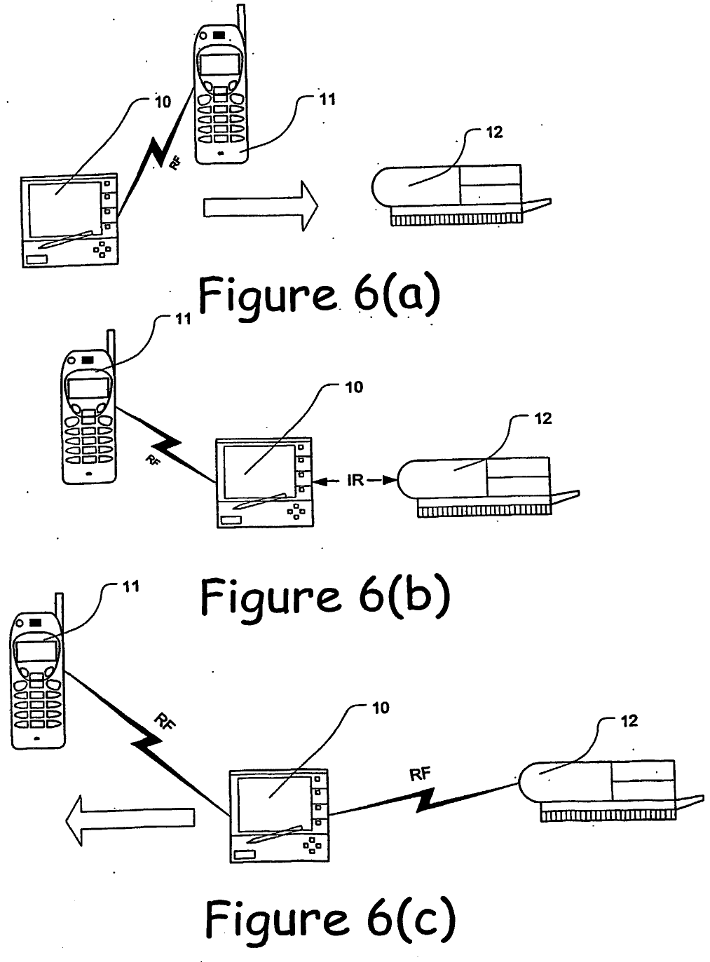

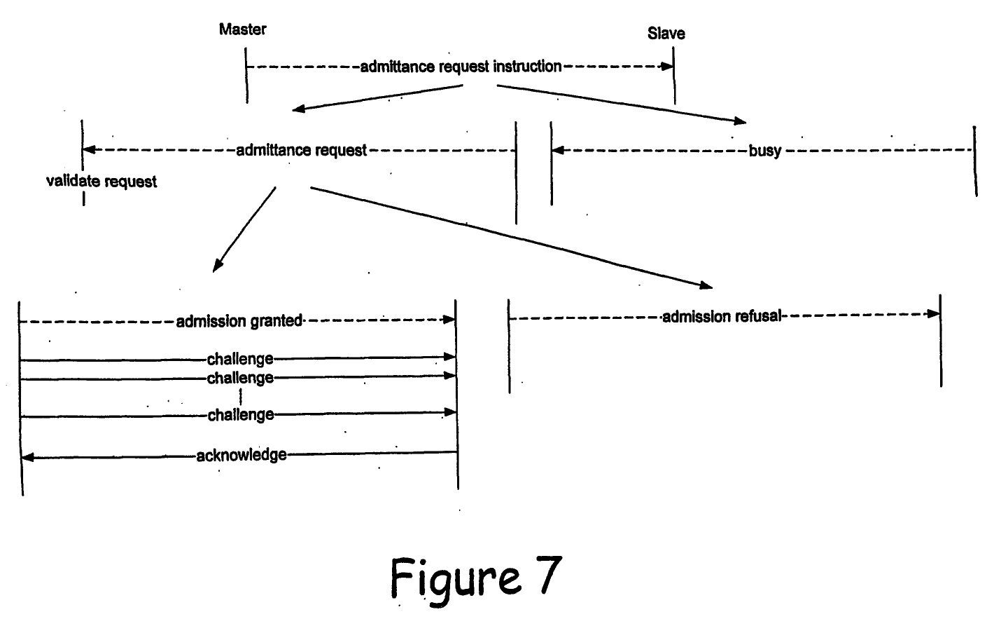

Referring to FIGS. 6 and 7, when the user of the PDA 10 wishes to add the printer 12 to the wireless network, the user aligns the ir port of the PDA 10 with that of the printer 12 and inputs a command into the PDA 10 which causes it to send an ir “admittance request invitation” signal to the printer 12.

When the printer 12 receives the “admittance request invitation” signal, it first determines whether it is already in a wireless network. If so, it replies with a “busy” signal. If not, the printer 12 sends an “admittance request” signal to the PDA 10. The “admittance request” signal includes the “name” of the printer 12 and a device type code. The PDA 10 determines whether the printer 12 is known to it and should be granted admittance automatically using the name and device type code. If the printer 12 is not recognised by the PDA 10, the PDA 10 displays a message for its user, asking whether the requesting device should be admitted as the ir “request demand” signal may have been received inadvertently by a device other than the printer 12. If the user responds by inputting “no”, the PDA 10 sends a “admittance denied” message to the requesting device. However, if the printer 12 did reply and is to be admitted, the PDA 10 sends an “admission granted” signal to the printer 12 using its ir subsystem 8. The “admission granted” signal comprises the name and device type of the PDA 10, its own wireless network address, a wireless network address to be used by the mobile phone, the pseudorandom number seed, a time slot number and a clock signal synchronised with the frequency hopping scheme established by the PDA 10. The clock signal terminates at the time slot identified in the “admission granted signal”.

As before, the PDA 10 begins to transmits a number of “challenge” signal packets addressed now to the printer 12 using its rf subsystem 8. When the printer 12 receives one of the “challenge” signal packets it responds with an “acknowledge” signal. If there is no response to the challenge signals, within a certain time or number of packets, the PDA 10 assumes that it has been rejected as a master by the printer 12 after all and stops signalling the mobile phone 11.

When the “acknowledge” signal has been received by the PDA 10, the PDA 10 sends new “reserved slots” signals to the other members of the wireless network informing them of the printer's reserved slots and the printer's network address.

While the wireless network is in existence, the PDA 10 polls each of the slaves every 60 seconds, if no reply is received from a slave device 11, 12 in response to two successive polls, the PDA 10 determines that it has absented itself from the wireless network, e.g. by going out of range, being switched off or being instructed by its user to ignore signals from the PDA 10. The PDA 10 responds to this by removing the absenting device's details from its network record and sending a new “reserved slots” message to any remaining slaves to inform them that the absenting device has left the wireless network and to modify their reserved slot lists.

The user of the PDA 10 may also eject a slave from the wireless network, as would be desirable after printing using a shared printer, by inputting a suitable command. The ejection is performed by the PDA 10 sending an “ejection” message to the device in question and sending new “reserved slots” message to any remaining slaves to inform them that the ejected device has left the wireless network and modify their reserved slot lists.

When there are no slaves left, the PDA 10 places its rf subsystem 7 in a standby mode in which it ceases to listen for signals or transmit signals. Similarly, where a slave leaves a wireless network, its rf subsystem 7 is also put in the standby mode.

Thus, the present invention provides a wireless networking system that avoids the problems inherent in the rf only approach adopted for Bluetooth.

In a modified form, the rf and ir subsystems and the programs for the processor 2 may be adapted to optionally operate according to the Bluetooth and irDA protocols so as to provide backwards compatibility. In this case, operation according to the present invention would preferably employ the Bluetooth bandplan.

It will be appreciated that the present invention may be embodied in many forms and the devices need not all be portable. For instance, a portable device such as a PDA or a mobile phone, could connect to a fixed master on entering a building by aligning the ir port of the portable device with a port, belonging to the master, provided conveniently at an entrance of the building.

In another embodiment, the ejection of a slave from a wireless network may be effected by sending a ir “eject” signal to the slave from the master, for example, in response to a user input, followed by a new rf “reserved slots” message to any remaining slaves to inform them that the ejected device has left the wireless network and modify their reserved slot lists. In this case, the user would not have the problem of identifying the device to be ejected from a possibly cryptic name stored and displayed by the master.

1. A method of establishing a wireless connection between two devices, the method comprising:
sending a first signal from a first device (10) to a second device (11, 12) by means of a point-to-point channel using other than radio frequency waves; and
sending a second signal from the first device (10) to the second device (11, 12),
characterised in that the first signal communicates set up information for a broadcast wireless rf channel (rf) to the second device (11, 12) and said broadcast channel is used for said second signal.

2. A method according to claim 1, wherein the point-to-point channel uses an optical carrier (IR).

3. A method according to claim 1 or 2, wherein the set up information includes data defining a frequency hopping scheme.

4. A method according to claim 1, 2 or 3, wherein the first signal includes an encryption key.

5. A method according to claim 4, wherein the second signal comprises data encrypted using said key.

6. A method according to claim 4 or 5, including sending a third signal from the second device (11, 12) to the first device, the third signal comprising data encrypted using said key.

7. A method of establishing a wireless network connection between two devices (10, 11, 12), the method comprising:, comprising:
sending a network admission request signal from the second device (11, 12) to the first device (10);
determining whether the second device (11, 12) should be admitted to a network including the first device (10); and
if it is determined that the second device (11, 12) should be admitted to the network, performing a method according to any preceding claim,
wherein the network admission request signal is sent in said point-to-point channel (IR).

8. A device having a communications facility, the device including an rf transceiver (7), a non-radio point-to-point transceiver means (8) and control means (2) for controlling the rf and point-to-point transceiver means (7, 8), processing data for transmission thereby and processing data received thereby, wherein the control means (2) is programmed such the device is configured to serve as the first device (10) or the second device (11, 12) in a method according to any preceding claim.

9. A device according to claim 8, wherein the point-to-point transceiver means (8) is an optical transceiver means.

10. A computer according to claim 8 or 9.

11. A mobile phone according to claim 8 or 9.

12. A printer according to claim 8 or 9.
